(19) United States
(12) Patent Application Publication
(10) Pub. No.: US 2011/0234809 A1
(43) Pub. Date: Sep. 29, 2011

(54) DUAL-LENS IMAGE CAPTURE DEVICE

(75) Inventor: SHIH-CHIEH YEN, Tu-Cheng (TW)

(73) Assignee: HON HAI PRECISION INDUSTRY CO., LTD., Tu-Cheng (TW)

(21) Appl. No.: 12/859,275

(22) Filed: Aug. 19, 2010

(30) Foreign Application Priority Data
Mar. 25, 2010 (TW) 99108838

(51) Int. Cl. H04N 5/33

(52) U.S. Cl. 348/164; 348/E05.09; 348/E05.091

(57) ABSTRACT

A dual-lens image capture device includes an optical conversion module, a first image sensor, a second imager sensor, a first lens, and a second lens. The optical conversion module includes an infrared light filter, a collimator, and a spectroscope. The infrared light filter filters infrared light of light from a light source and allows visible light from the light source to pass through. The collimator converts the visible light into parallel beams. The spectroscope is placed at one side of the collimator away from the infrared light filter, and reflects a portion of the parallel beams and allows remaining parallel beams to pass through. The first lens receives the reflected parallel beams, and focusing the beams onto the first image sensor. The second lens receives the passed parallel beams, and focusing the beams onto the second image sensor.

### BACKGROUND

1. Technical Field

The present disclosure relates to image capture devices and, particularly, to a dual-lens image capture device.

2. Description of Related Art

A conventional image capture device, such as a mobile phone with a image capture module, usually includes only one lens for capturing various kinds of images at different settings according to user selected options. However, quality of the images and shooting options are limited according to the characteristics of the one lens.

Therefore, what is needed is a dual-lens image capturing device to overcome the described shortcoming

### BRIEF DESCRIPTION OF THE DRAWINGS

FIG. 1 is a block diagram of hardware infrastructure of a dual-lens image capture device in accordance with an exemplary embodiment.

FIG. 2 is a block diagram of hardware infrastructure of a dual-lens image capture device in accordance with a second embodiment.

FIG. 3 is a block diagram of hardware infrastructure of a dual-lens image capture device in accordance with a third embodiment.

### DETAILED DESCRIPTION

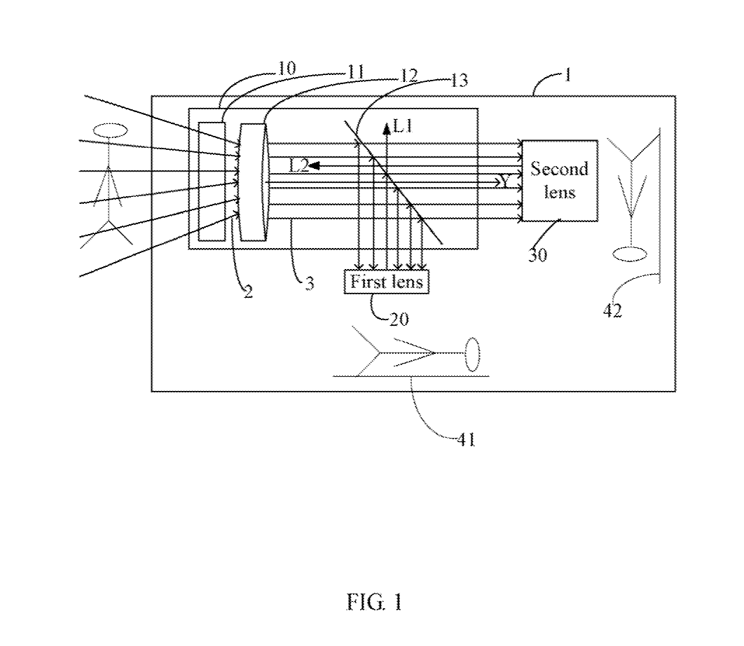

Referring to FIG. 1, a dual-lens image capture device 1 is illustrated. The dual-lens image capture device 1 includes an optical conversion module 10, a first lens 20, a second lens 30, a first image sensor 41, and a second image sensor 42. The optical conversion module 10 is configured for receiving light from a light source. In the embodiment, the light from the light source includes visible light and infrared light. The optical conversion module 10 is further configured for changing a path of the visible light.

The optical conversion module 10 includes an infrared light filter 11, a collimator 12, and a spectroscope 13. In the embodiment, the collimator 12 includes an optical lens.

The infrared light filter 11 is configured for filtering the infrared light, and can allow the visible light 2 to pass through.

The collimator 12 is placed at one side of the infrared light filter 11 away from the light source, and is configured for converting the permeated visible light into parallel beams 3. In the embodiment, the collimator 12 includes a Y axis as its optical axis in parallel with the beams 3.

The spectroscope 13 is placed at one side of the collimator 12 away from the infrared light filter 11 and is inclined relative to the Y axis of the collimator 12. The spectroscope 13 is configured to reflect a portion of the parallel beams 3 and allow the remaining parallel beams 3 to pass through. In the embodiment, the inclined angle of the spectroscope 13 is determined based on properties of the spectroscope 13 including reflectivity and transmittance.

The first lens 20 is configured for receiving the reflected beams 3 from the spectroscope 13, and focusing the reflected beams onto the first image sensor 41 to form images, such as one of still images or videos. The second lens 30 is configured for receiving the remaining beams 3 from the spectroscope 13, and focusing the remaining beams onto the second image sensor 42 to form images, such as the other one of still images or videos. In other embodiments, lenses can selected according to desired effects, such as for wide angle shots, close up shots, and fish eye effect for example. In the embodiment, the first image sensor 41 and the second image sensor 42 may be either of a charge-coupled device (CCD) or a complementary metal-oxide-semiconductor (CMOS). The first lens has an optical axis vertical to the optical axis of the collimator, and the second lens has an optical axis aligned with the optical axis of the collimator. As shown in FIG. 1, the first lens 20 focuses the reflected beams onto the image sensor 40 to form an image.

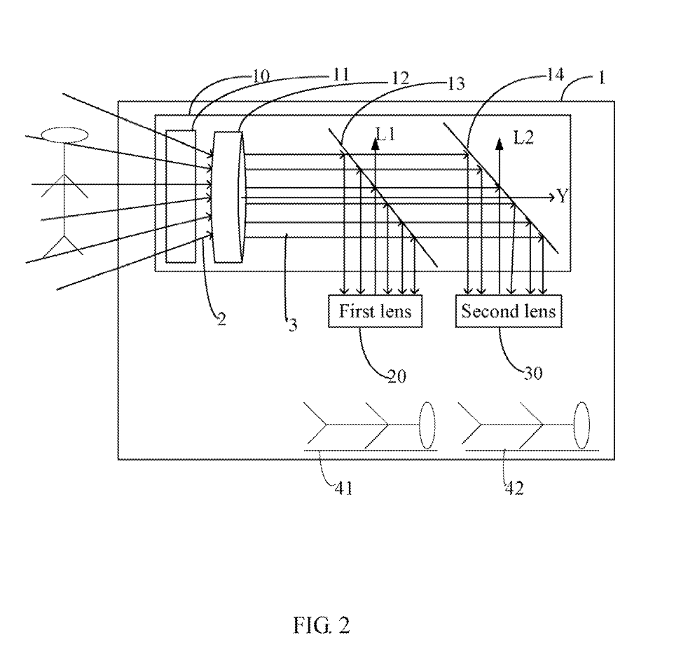

Referring to FIG. 2, in a second embodiment, the optical conversion module 10 further includes a holophote 14. The holophote 14 is placed at one side of the spectroscope 13 away from the collimator 12, and is inclined relative to the Y axis of the collimator 12. The holophote 14 is configured for fully reflecting the passed remaining beams 3 from the spectroscope 13 to the second lens 30. In the embodiment, the optical axis of the first lens 20 and the second lens 30 is respectively vertical to the optical axis of the collimator 12 and the lens 20 and the second lens 30 are placed at the same side of the optical axis of the collimator 12.

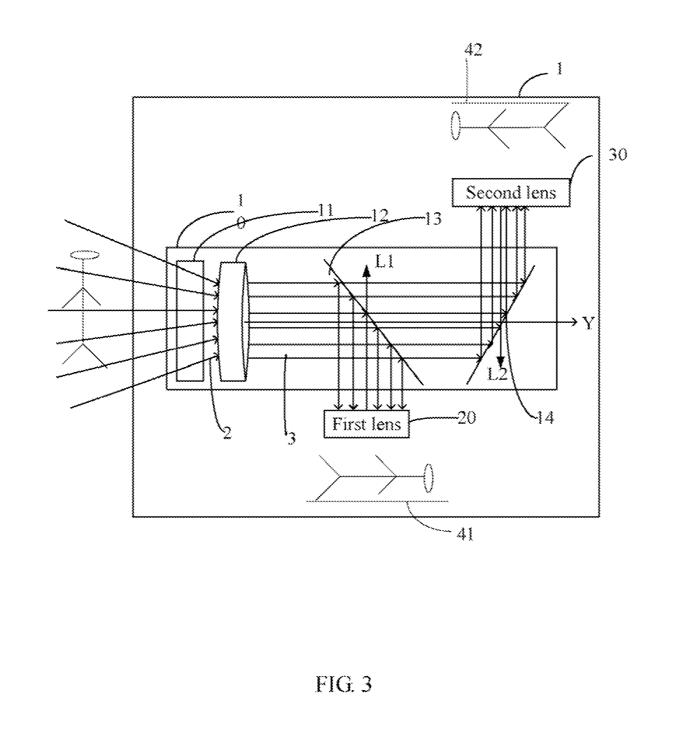

Referring to FIG. 3, a third embodiment is disclosed, similar to the second embodiment, except that the holophote 14 is oriented differently and the first lens 20 and the second lens 30 are placed at opposite sides of the optical axis of the collimator 12.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. A dual-lens image capture device comprising:
an optical conversion module comprising:
an infrared light filter configured for filtering infrared light of light from an light source and allowing visible light from the light source to pass through;
a collimator placed at one side of the infrared light filter away from the light source, and configured for converting the visible light into parallel beams; and
a spectroscope placed at one side of the collimator away from the infrared light filter at an inclined angle with the parallel beams, and configured for reflecting a portion of the parallel beams and allowing remaining parallel beams to pass through;
a first image sensor;
a second image sensor;
a first lens configured for receiving the reflected parallel beams from the spectroscope, and focusing the reflected beams onto the first image sensor; and
a second lens configured for receiving the passed parallel beams from the spectroscope, and focusing the passed beams onto the second image sensor.

2. The dual-lens image capture device as described in claim 1, wherein the first image sensor and the second sensor are charge-coupled devices.

3. The dual-lens image capture device as described in claim 1, wherein the first image sensor and the second image sensor are complementary metal-oxide-semiconductors.

4. The dual-lens image capture device as described in claim 1, wherein one of the first image sensor and the second image sensor is a charge-coupled device and the other is a complementary metal-oxide-semiconductor.

5. The dual-lens image capture device as described in claim 1, wherein the collimator comprises an optical axis parallel to the parallel beams.

6. The dual-lens image capture device as described in claim 5, wherein the first lens has an optical axis vertical to the optical axis of the collimator, and the second lens has an optical axis aligned with the optical axis of the collimator.

7. The dual-lens image capture device as described in claim 1, wherein the optical conversion module further comprises a holophote placed at one side of the spectroscope away from the collimator, the holophote is inclined relative to the parallel beams and is configured for fully reflecting the passed parallel beams from the spectroscope to the second lens.

8. The dual-lens image capture device as described in claim 5, wherein the first lens and the second lens are placed at the same side of the optical axis of the collimator.

9. The dual-lens image capture device as described in claim 5, wherein the first lens and the second lens are placed at opposite sides of the optical axis of the collimator.

10. The dual-lens image capture device as described in claim 1, wherein the optical conversion module comprises an optical lens.
